(19) United States
(12) Patent Application Publication
(10) Pub. No.: US 2012/0253963 A1
(43) Pub. Date: Oct. 4, 2012

(54) System and Method for Consolidating Purchases of Goods and Services

(76) Inventor: Ian Saul Becker, San Diego, CA (US)

(21) Appl. No.: 13/526,447

(22) Filed: Jun. 18, 2012

Related U.S. Application Data
(63) Continuation-in-part of application No. 12/688,133, filed on Jan. 15, 2010.
Application No. 12/688,133 is a continuation-in-part of application No. 10/844,175, filed on May 12, 2004, now abandoned.
(60) Provisional application No. 60/482,841, filed on Jun. 26, 2003.

(51) Int. Cl. G06Q 30/06

(52) U.S. Cl. 705/26.2

(57) ABSTRACT

A system and method for consolidating the purchase of goods and services is disclosed. Users select or create a request that defines a desired product or service, where others can view and join the open request. Upon the occurrence of an event, all joined users are notified of the cost of purchasing the requested good or service and given the opportunity to accept or reject the solution to the request. If one or more users reject the solution, the cost per user is recalculated and users are notified again until all users accept or reject the solution. The cost for each individual user is the total cost of purchasing the good or service divided by the total number of joined users.

### CROSS REFERENCE TO RELATED APPLICATIONS

This application is a continuation-in-part of U.S. patent application Ser. No. 12/688,133 filed on Jan. 15, 2010, which in turn is a continuation-in-part of U.S. patent application Ser. No. 10/844,175 filed on May 5, 2004, which in turn is a non-provisional of U.S. Provisional Patent Application No. 60/482,841 filed on Jun. 26, 2003, the entireties of which are hereby incorporated by reference.

### STATEMENT REGARDING FEDERALLY SPONSORED RESEARCH OR DEVELOPMENT

This invention was not federally sponsored.

### BACKGROUND OF THE INVENTION

This invention relates to a system and method for consolidating purchases of goods and services and more specifically towards a system and method for consolidating purchases of goods and services that enables buyers to equally share the cost of the good and/or service by consolidating their purchase.

To fully understand the system and method of the current invention, it is necessary to understand how products and services have been priced. Historically, commercial transactions have always been supply centric. Commerce has been about arranging and organizing the supply of goods and services, then locating retailers to sell these products and services to individuals. In most cases individual consumers do not have the wherewithal to purchase the product or service in bulk directly from the source. The cost is just too high for any one individual or entity to afford.

The legacy, supply-centric, sequence of selling goods and services has many risks for the suppliers. For instance, vendors of products and services who sell their wares to consumers by units that they have “decanted” often are left with excess inventory, or empty non-revenue generating seats, cabins, and other perished goods. To compensate for these frequent losses, expensive yield, or revenue enhancing techniques are deployed. These forces raise prices.

For instance, airlines suffer from empty seats; cruise lines have empty cabins; classrooms have space for extra students; concerts, sporting events and other entertainment venues also have non-sold seats; condo and other real estate developments have units that go unsold; and in capital raising finance funding services, there are times when there are not enough investors to purchase an offering. Supply side distribution cannot balance supply with demand as efficiently as the consolidating engine herein does in balancing the demand in real time.

It is also helpful to review the history of commercial airline schedules for a frame of reference. Before commercial airlines, there were railroads, and even before them, commercial transportation was offered over ocean, river, and lake by ship. Booking a passage on a ship became routine. The railroads adopted this legacy system. The railroads introduced the concept of repetitive schedules with the publishing of their timetables, and the standardization of time throughout the US.

The railroads published their repetitive schedules in an effort to popularize and promote their services. Potential customers could now choose on which precise train they wanted to travel. Departure date and time, as well as arrival date and time were, in fact, guaranteed by the railroads. This development facilitated the selling of advance seats for travel on a particular train. Ships and stagecoaches could not compete with this reliability.

The concept of publishing schedules meant that the carrier, initially the railroads, and later, the airlines had to invest in assets and commit to the published schedule. In order for these transportation companies to gain the trust of their customers, they had to adhere to these schedules.

Therefore, “schedule” has inherent in it the concept of preexisting investment in resources so as to perform the scheduled routing. Also, “schedule” is inherently repetitive.

For a scheduled route to be offered, there had to be an investment in resources by the carrier. Aircraft, or trains, had to be set aside and dedicated to travel that route. Tickets, seats, or a reservation for travel were sold on each scheduled trip. This lead to the concept of per-seat cost accounting and marketing. Thus, prior art booking and reservation systems are supply centric. They are not focused upon the travelers' demand proclivities.

The downside of this “publishing of schedules” was that even if only a handful of tickets were sold on a particular scheduled routing, the operator (the transportation company or carrier) could not cancel the journey even though it would be conducted at a loss. This uncertainty and risk caused by empty seats necessitated the introduction of yield management techniques. Yield management forced the carriers to examine all their schedules and adjust prices so that the popular times and routings were sold at higher prices than unpopular ones.

After World War II, airlines in the US grew rapidly, and matured. They adopted the concept of publishing their schedules and the selling of seats on these schedules in an effort to compete directly with the railroads.

Booking of seats for transportation could be bought via a few channels. Airlines sold seats to travel on their schedules at airports, from their downtown offices, which were located in most of the major cities the airlines served, and through third parties such as travel agents.

The routes of US domestic airlines operate on two models.

1. Hub-and-spoke,

2. Daisy-chain.

These allow airlines to offer many destinations to their customers, carry more passengers, optimize aircraft utilization, and facilitate crew changes. Although these models allow many cities to be linked by one carrier, time spent changing planes or just stopping to load and unload passengers is very time consuming. These models have made direct non-stop service rare.

Yield management has evolved to the point where few tickets, even on the same flight, are sold at the same price. Fluctuations in price, even on the same flight, are influenced by when the ticket is purchased in terms of the number of days before the flight. The closer to the actual flight departure the more expensive the ticket becomes. Seat prices are not fixed, even on the same flight. Prices also differ depending through which channel (internet, agent, airline, Global Distribution System, etc.) they are purchased.

The creation of schedules presupposes that assets are deployed and reserved to deliver the routings as published. Carriers operate a scheduled routing even though only a few seats are sold. Carriers assume or incur the loss involved with such a flight. Therefore, some flights are more profitable than others.

An airline seat is a very perishable commodity. Once the aircraft takes off, each empty seat is a loss of revenue and can never be recovered. The profitability of a flight is a function of the load factor, or put another way: the fewer empty seats on a particular flight the more profitable it is.

Axiomatically, schedules are restrictive for the traveling public. Travelers can only fly when and to where the published schedule permits. Often, to get to a designated destination, a traveler has to patch together a few proffered schedules from more than one airline. This involves changing planes and often suffering long wait times at airports. Wait time at airports is often longer than actual flight time to the destination.

The most common method of air travel is via commercial airlines. Presently, commercial airlines service approximately 400 airports across the United States, flying to and from about 30 hub airports. There are, in fact, more than 5,000 operational airports in the United States.

Commercial airline service is expensive in terms of time, productivity, and money. Fares have risen dramatically in the last few years. Airlines have made significant cuts in the number of flights they offer. Today, airline schedules are not guaranteed. Most routes are circuitous. Direct, non-stop routes are rare. Passengers are often stranded because of these capricious schedules. This wreaks havoc with their travel plans. Security check points, although necessary, are unfortunately time consuming. Consequently, time spent at airports is often longer than time spent actually flying. The net result is that commercial airline passengers are frustrated and dissatisfied.

Private, or charter flights offer an alternative that is infinitely more flexible and productive. Because, by definition, they are on-demand, point-to-point, direct, and non-stop. J D Power & Associates reports that traveling by private plane will save frequent fliers a month of productive time annually. The main issue associated with charter aircraft is, of course, the exorbitant price.

Private flights operate to and from most of the 5,000 currently available airports across the United States. By avoiding the major airports serviced by the commercial airlines, and by flying directly to an elected destination, private charter flights offer optimum efficiencies in terms of time and productivity. However, chartering an aircraft is generally only available by the entire aircraft. This is changing, though, with the industry's new advent of the air-taxi, where flights on private jets are charged on a per-seat basis.

Various methods exist to order, rent, or book charter flights in person and on-line from owners and operators of private aircraft, but the prior art does not dwell on charter by individuals. The prior art does not offer a method or system whereby a plurality of passengers can independently charter the same aircraft for the purpose of equally sharing the costs. The prior art does not address any method to reduce the cost of private air charter by sharing, consolidating or amortizing the passenger load and thereby the actual cost to the individual traveler. Nor does the prior art disclose consolidating or aggregating a plurality of passengers' itineraries over a media such as the internet for the purpose of enabling passengers to equally share the cost of private jet flight.

Because chartering or renting is presently readily available only for the entire aircraft, it is prohibitively expensive for the individual traveler, especially when compared to purchasing a single ticket on commercial airlines. An individual traveler wanting to fly directly from a designated departure point to an elected destination has to rent or charter the entire aircraft for himself or herself.

Therefore, the need arises for a means to open these private flights to more than one passenger at a time. More specifically, an easily accessible system and method is needed whereby a plurality of passengers can independently create and arrange their own routings or itinerary and then consolidate these unique routings with other passengers for the express purpose of sharing a charter or rented aircraft, so as to reduce the cost per passenger.

The need arises for a method that enables individual passengers to share the costs of chartering, while administrating and managing the details of the chartering process. Plus, there is a need for removing or mitigating the operator's inherent risk associated with selling charter flights to a plurality of passengers per flight on a per seat basis. The results would be: (a) private aircraft charter at a price comparable to commercial airline unrestricted fares, and (b) avoiding the circuitous, time-wasting routing and check-in procedures of the commercial airline paradigm.

There is a need for a point-to-point, affordable, per-passenger fare basis to charter or rent an aircraft that would provide an alternative to both commercial airlines and private by-the-entire-aircraft charter offerings.

The per-passenger pricing model should not be confused with the per-seat pricing model. Per-seat pricing presupposes a prior investment in a specific product to resell at a profit. Commercial airlines use this system to price and sell seats on their scheduled flights for a profit.

For example, assume that a demand exists from “City A” to “City B” on any given day for 20 travelers. If these assumptions are perfect, a 20 seat aircraft can be arranged for the trip. Let us further assume that the total all-inclusive cost of this aircraft to fly from City A to City B is $1000, including all taxes and overhead. If this trip is sold at $100 per seat, and all 20 seats are sold, the total income from the flight would be $2,000, which in this scenario is a 100% return on investment.

However, if only 10 seats are sold by the time the aircraft takes off, then the airline and/or aircraft operator would break even on its investment, since 10 seats sold at $100 per seat results in $1,000 of income. If less than 10 seats are sold, then the result of the flight would be a net loss. These are some of the risks and uncertainties associated with the per-seat-pricing model.

The per-passenger pricing model, on the other hand, is predicated upon enabling all those who choose to fly to equally share the total cost of the flight. Further, by outsourcing the supply of inventory from the huge base of owners and operators of private jets, capital outlay can be optimized. This supply of quality just-in-time inventory is almost infinitely flexible. These jets come in different sizes and capabilities. Moreover, they are available at reliable market pricing.

Demand for private jet flight is healthy and growing. What is not known and cannot be easily determined is when and where this demand wants to fly. It is constantly changing and could be from anywhere to anywhere at anytime.

Therefore, a market presence is required where this demand can be cultivated and harvested in real-time in order to aggregate it. Travelers are grouped or consolidated so that they can equally share the total cost of a flight that benefits them, while at the same time the total price of the flight is set to achieve the targeted margins of the aircraft operator. This is the essence of the per-passenger pricing model. It is relatively risk free to the operator, who can now offer the aircraft for charter as sustainable profit margins that can be built in. Per-passenger pricing reduces the uncertainties and scheduling problems. Per-passenger pricing is traveler-oriented as it accommodates all the nuances of market demand, and market fluctuation. Because per-passenger pricing mitigates operator risk, it influences prices downward thereby increasing customer usage and satisfaction as well as demand for the invention.

For example, let's assume “Passenger Z” wishes to fly from “City A” to “City B.” Let us further assume that the only aircraft available seats 20 passengers and that the total cost of this aircraft to fly from “City A” to “City B” is $10,000, including all taxes and overhead. The profit margin that the aircraft operator might seek could be 100%, thereby requiring that a total price of $20,000 be paid for the flight. However, Passenger Z is not willing to spend $20,000. Therefore, Passenger Z is not willing to charter the entire aircraft by himself.

Now let's assume that four additional passengers, “Passengers Q, R, S, and T,” are looking for a flight to and from the same cities at approximately the same time as Passenger Z. Collectively, they are also unwilling to charter the entire aircraft by themselves.

If these passengers are able to group or consolidate their usage so as to travel on the same aircraft simultaneously, then the flight will make economic sense to all parties concerned. The total number of passengers on the aircraft will now be 5. The cost per-passenger of the $20,000 flight will be $4,000. The 5 passengers, each paying $4,000, combine for a total income of $20,000 to the aircraft operator for the flight, resulting in the 100% profit margin sought by the operator. Each party involved benefits from the transaction. The operator receives the compensation he desires. The problems associated with empty seats have been eliminated. Passengers Z, Q, R, S, and T each get his or her desired flight at acceptable cost. Note: The invention does not require a prime mover to take a risk by proposing a routing. All proposals are treated as mere inquiries, which are without financial or contingent obligations.

Now let's assume that an additional 10 passengers are found that also wish to travel on the same flight. The total number of passengers on the flight would be 15 leading to a per-passenger cost of about $1,330. The operator still receives his 100% profit margin. Each individual traveler though receives a flight of his or her choice at a cost that, in all probability, is only slightly more than what it would cost to fly on a commercial airline.

Further, because just-in-time inventory is utilized, a smaller aircraft could be used to further reduce the overall cost to the operator, and therefore the overall cost to the passenger, while maintaining the desired profit margin for the operator. Alternatively, if a greater number of passengers desire to fly to and from the same cities at approximately the same time, a larger aircraft could be used to accommodate the demand. This would lead to even further reduced prices for each passenger to travel on the flight.

Per-passenger pricing is variable and flexible. The price that each passenger pays depends not on the number of seats on the aircraft, but rather the total cost of flying the aircraft from one location to another, the desired profit margin of the operator, and the total number of passengers that end up on the flight. Since the number of passengers on the flight can change, so can the price that each passenger pays. It maximizes opportunities while minimizing risk and uncertainties. It produces favorable prices for travelers while at the same time giving them the exact flight they desire which also saves them time when compared to travel via commercial airlines.

### SUMMARY

The system and method of the present invention for the consolidation of the purchase of goods and services represents an entirely new and novel solution to the problems and inconveniences of purchasing high-priced goods and services. The consolidating engine of the current invention delivers a risk-eliminating solution.

The invention assembles, or groups demand, in real time via the internet. It eliminates seller's risks of unused, excess or unclaimed inventory. It reduces prices for consumers. It boosts efficiency across the transaction.

The invention consolidates the demand in real time across a plurality of like-minded potential consumers. The entire service/product has an exact global price. For example, it might cost a couple million dollars to hire the Rolling Stones; tens-of-millions to get preferable investment terms; and hundreds-of-millions to develop a real estate property. The invention uses the internet's collaborative power to enable individual consumers to group together and take an equal share in previously cost-prohibitive services or products. When the price point is one million dollars to purchase a product, any individual could purchase the product for one million dollars. However, one million purchasers (buyers or users)—consolidated by the invention—could purchase the product for one dollar each. Furthermore, there can be scaling proportion in between. Continuing the example, one thousand purchasers would have to pay one-thousand dollars or one-hundred-thousand users would have to pay ten dollars each.

Via the internet, the current invention consolidates disparate user demand by consolidating their demand in real time. This enables the sharing of various products and services. The sharing reduces the price dramatically for each user. It has been said that tournaments typically start with many participants and end with one winner who gets the prize. The current invention, by contrast, is an “inverse tournament.” It starts with the market established price when one person requests, or posts a request, for a product or service, and continues until a plurality of people share the product or service, each paying a lower price then if each had purchased individually.

It is axiomatic that the greater the number of purchasers that share the cost of a good or service, the less the cost to each buyer. The main attribute of the present invention is to provide a method and system that enables purchasers to share the costs of high-priced products and services.

It is an aspect of the present invention to enable like-minded users to share in the use of a service or consumption of a product.

It is a further aspect of the present invention to reduce or even eliminate risks in selling goods and services, streamline supply chains, remove demand uncertainty, lowers prices, and make more products and services available to a greater number of consumers.

It is another aspect of the present invention to enable a plurality of passengers to share the benefits of chartering a private aircraft in order to make said travel more affordable.

It is another aspect of the present invention to enable a plurality of passengers to have access to private aircraft travel without having to rent or pay for an entire aircraft individually.

It is another aspect of the present invention to provide an automated means for passengers to independently create their unique flight routings, and then find similar routings in order to consolidate these routings so as to share the costs of renting or chartering an aircraft equally among themselves.

It is another aspect of the present invention to provide a method and means of enabling passengers, desirous of sharing a flight and the cost of a flight on a per-passenger basis, to share their routings with others of like travel-desires.

It is another aspect of the present invention to allow passengers, desirous of chartering or renting a private aircraft, a method and means of reserving a trip or passage for that flight.

It is another aspect of the present invention to allow passengers desirous of traveling on private aircraft this service without any upfront capital investment.

It is another aspect of the present invention to allow owners and operators the opportunity to charter or rent their aircraft to a plurality of travelers per designated trip without the risks of per-seat costs and bookings.

As used herein, goods and products are interchangeable. References to goods and services shall mean goods or services as well, and goods or services shall mean goods and services as well. The system and method of the current invention is also referred to as a consolidating engine. Vendors shall include manufacturers or any other entities that provide goods and/or services for a fee. A user, purchaser or buyer is a person who is using the system and method described herein to purchase a good or service. A user could be a member of a defined group, a legal entity, or could be any internet user. The system of the current invention could be located on a server, multiple servers, implemented on a cloud computing system, or other like structures. A request is the description of the service or product the user wants. The consolidating engine will be configured so that a user can adequately describe the service or product easily. An open request is a request accepted by the consolidating engine, and includes an interest list of all the users who have indicated that they are desirous of purchasing the product of service. A closed request has an interest list that is fixed and is populated by only those users who have committed to purchase the product or service, to which no more users may be added to the interest list. Total price is the total, all-inclusive price of the product or service requested by the user. Any one user could acquire this product or service at this price. Price per user is the total price divided by the number of users in the open interest or closed interest list. A solution is the system's response to the request. This would usually be displayed as a description plus the total price to acquire the product or service. If there are already interested users the system will also display the number of present users, and the present price per user. Limits or limiting events are events that require a user to make a decision, specifically whether or not to purchase the product or service at the specified price per user. Examples of limiting events are the expiration of a period of time, the maximum number of users allowed on a particular interest list, or a minimum price per user.

In a particular embodiment, the current invention includes a system for consolidating a purchase of a product or service among a plurality of users comprising a computer readable medium and a server system, where the computer readable medium stores data, where the server system is configured to store requests in the computer readable medium, where a request comprises a product or service and an associated total cost, where the server system is configured to receive a request for product or service from a user over the internet, wherein the request comprises product or service criteria, and transmitting a response of open requests based upon the criteria, where the server system is configured to join one or more users to an open request whereby the one or more users are added to an interest list, where the server system is configured to calculate a price per user, where the price per user is the total cost for the request divided by the number of users on the interest list of the request, where the server system is configured to notify users on the interest list of an open request upon an occurrence of a limiting event, where upon notification, users can accept or reject the request, where upon one or more users rejecting the request, removing the users that rejected request from the interest list, recalculating the price per user, and notifying users of the interest list of the request, where upon all users accepting the request, closing the request.

In another embodiment, the current invention includes a method for purchasing a product or service over the internet comprising receiving search criteria for a product or service from a user, where the user sends the search criteria through a web browser; sending open requests to the user, where the user can view the open requests through a web browser; joining the user to an open request; joining additional users to the open request; and notifying the users upon the occurrence of a limiting event, where the users are notified of the price per user of the request, where the users are allowed to accept or reject the open request; where the open request has a total cost, where the price per user is the total cost divided by the number of users that have joined the open request.

In yet another embodiment, the current invention includes a method for purchasing a product or service comprising receiving search criteria from a user, where the user sends the search criteria through a web browser; sending open requests to the user, where the user can view the open requests through a web browser, where each open request comprises a price per user; joining the user to an open request; joining additional users to the open request; and notifying the users upon the occurrence of a limiting event, where the users are notified of the price per user of the request, where the users are allowed to accept or reject the open request; and recursively removing users that reject the open request, recalculating the price per user, and notifying the users still joined to the open request until either all users accept the open request or all users are removed from the open request; where the open request has a total cost, where the price per user is the total cost divided by the number of users that have joined the open request.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a schematic view of the interactions of the system with passengers and charter aircraft operators according to selected embodiments of the current disclosure.

FIG. 2 is a flow chart illustrating the method with which a passenger books transportation according to selected embodiments of the current disclosure.

FIG. 3 is a flow chart illustrating the method with which a buyer purchases a good or service according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

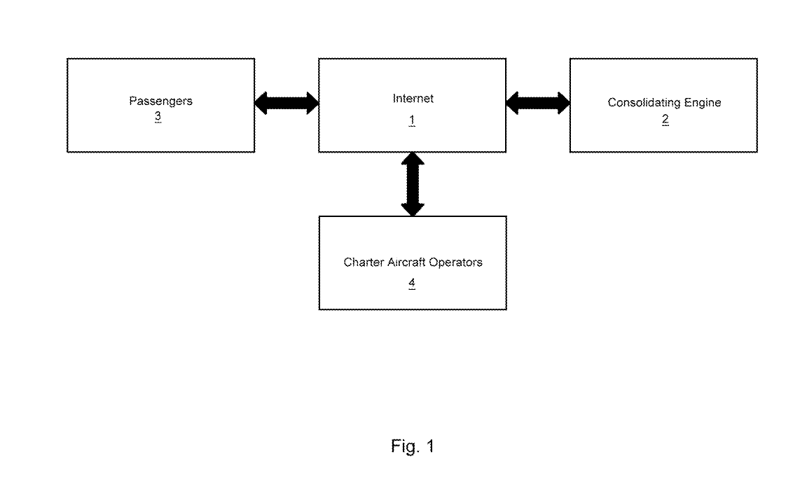

FIG. 1 is a schematic view of the interactions of the system with passengers and charter aircraft operators. Passengers 3 interact with the system 2, also called the consolidating engine, via the Internet 1. Preferably, passengers 3 access and interact with web accessible servers of the system 2 through a web browser. The system 2 also interacts with charter aircraft operators 4. This can be through various means. One such means is through a standard algorithm that is integrated into the system. Charter aircraft operators 4 can manipulate various settings directly or through the Internet using a web browser. Alternatively, the system can query relevant information, such as the cost of a particular flight listing, by request such information from charter aircraft operators servers', whereby the interactions are achieved over the Internet. For example, charter aircraft operators may create an application programming interface (API) that enables the system 2 to request and receive costs of flight listings for use with passenger selected flight listings.

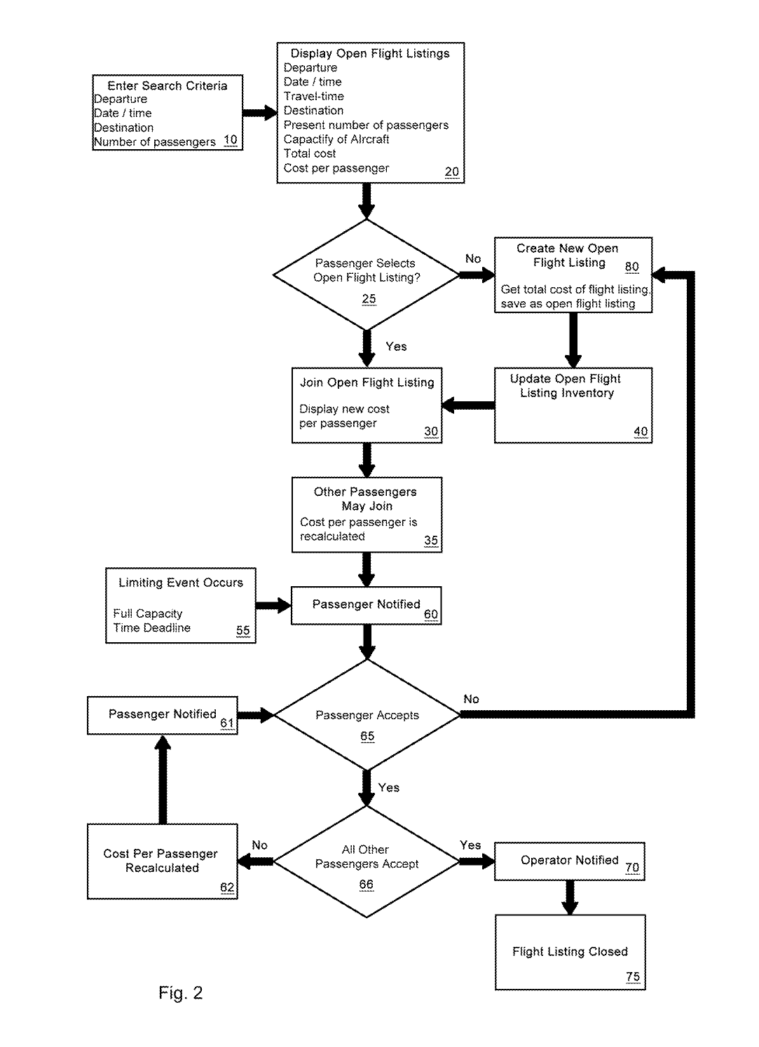

FIG. 2 is a flow chart illustrating the method with which a passenger books transportation according to the current invention. To begin, a passenger enters search criteria 10 that include information such as the departure location, the date and time of departure, the destination location, and the number of passengers that will be travelling. This information is preferably entered into a form within a passenger's web browser. The passenger fills out the request information and then submits it to the system via the Internet. Other search criteria can include the type of transportation, such as the type of aircraft, available amenities, travel time, and return trip information.

Once the search criteria is submitted to the system 2 by the passenger 3, the system 2 searches for open flight listings that match to the search criteria submitted by the passenger 3. The system displays the relevant open flight listings 20 to the passenger, preferably through a web browser. The passenger can then browse the available open flight listings, which preferably include the departure location, date and time of departure, travel time, destination, present number of passengers that have joined the particular flight listing, the capacity of the means of transportation, such as an aircraft, the total cost of the flight listing, and the current cost per passenger, assuming the passenger (and any additional individuals that the passenger may be reserving travel for) joins the flight listing.

One of the key aspects to the current system and method is the cost per passenger. The cost per passenger is calculated by taking the total cost of the flight listing and dividing it by the present number of passengers associated with the flight listing. The total cost includes the price charged by the charter aircraft operator to provide the transportation service according to the flight listing, any taxes, fees, or other government charges, any amounts charged by the provider of the system and method according to the current invention, and any other cost that must be paid by the passengers collectively to travel the flight listing. Accordingly, the cost per passenger changes as the present number of passengers change. As more passengers join an open flight listing, the lower the cost per passenger.

After browsing the relevant open flight listings, the passenger has the option of selecting an existing open flight listing 25. Upon such a selection, the passenger joins the open flight listing 30 and the system sends a confirmation to the user, preferably through both the web browser and via email. The system updates the open flight listing with the new number of passengers that have joined the flight listing.

Alternatively, the passenger may decide that no open flight listing is acceptable, but still wishes to continue with his or her own flight listing according to his or her search criteria. The user may then choose his or her own flight listing. The system creates a new open flight listing 80. At this time, the system gets the total cost of traveling the flight listing from one or more charter aircraft operators. While this is preferably done in real time, whereby the system queries the charter aircraft operators through an API or calculates the total cost through an algorithm approved by the charter aircraft operators, it is nonetheless possible to manually request the total cost from the charter aircraft operators and then manually enter the data into the system. However, if performed manually, the step of creating a new open flight listing may be put on hold until said data is entered into the system. If multiple charter aircraft operators submit a total cost, it is preferably though not necessary to choose the lowest total cost and select that charter aircraft operator. Upon obtaining the total cost of the flight listing, the flight listing is saved into the system and the system updates open flight listing inventory 40. The passenger joins the open flight listing 30 and the system sends a confirmation to the user, preferably through both the web browser and via email. The system updates the open flight listing with the new number of passengers that have joined the flight listing.

After joining an open flight listing 30 (or before, as the case may be), other passengers may join 35 the flight listing using the same method described above. As new passengers join, the cost per passenger is recalculated to reflect the new present number of passengers that have joined the open flight listing. Other passengers may continue to join until a limiting event occurs 55. Such limiting events include the specified aircraft (or other means of transportation) used to fulfill the flight listing becoming full, or a time deadline is reached where there is a minimum amount of time left before the flight listing is intended to depart. When a limiting event occurs 55, the passenger is notified 60 and given the option of accepting or rejecting the flight listing for the current cost per passenger 65. Up until this point, the passenger is not obligated to follow through with any payment or travelling the flight listing. If the passenger does not accept the flight listing, the passenger can create a new open flight listing 80 using the same data as the former flight listing. Alternatively, the passenger can simply exit the system or begin the method again by entering new search criteria 10. If the passenger does accept the flight listing, then he or she must wait for all other passengers to accept 66. Notifying passengers is preferably achieved by sending an electronic mail message (email message) with the relevant data and a link that allows them to view and accept or reject the flight listing, either through the email browser, a web browser, or any interactive communication medium or device.

For the passengers to book the flight listing and be obligated to pay for the travel all of the passengers that have joined the flight listing must agree to their pro-rata share of the cost of traveling the flight listing. Thus, when all the passengers of a flight listing accept the price and agree to travel, the operator is notified 70 and the flight listing is closed 75.

However, it is likely that one or more other passengers may choose to reject (not accept) the flight listing. At this point, the rejecting passenger is removed from the open flight listing, and the cost per passenger is recalculated 62. The passenger is notified 61 of the new cost for travelling the flight listing, and is once again given the option of accepting or rejecting the flight listing at the new cost. This happens recursively until all passengers accept the flight listing or there are no passengers remaining on the flight listing.

As an example of the current method, passenger A enters search criteria to travel from “City X” to “City Y” in two weeks time for two total passengers. After finding no acceptable open flight listings, passenger A joins his own flight listing. The total cost of travelling from City X to City Y is determined to be $10,000, and thus currently it will cost $5,000 per passenger. A week later, passenger B searches for a similar route, and decides to join the flight listing created by passenger A, with an additional passenger. Now there are 4 total passengers choosing to travel the flight listing created by passenger A at a cost per passenger of $2,500. The next day, passenger C also joins the flight listing. At this point, the cost per passenger becomes $2,000. Two days before the flight listing is intended to depart, the system notifies the passengers that have joined the flight listing that they can travel this flight listing for $2,000 per person, subject to all current passengers accepting the flight listing. Passengers A and B accept the flight listing, but passenger C does not. The new cost per passenger is calculated to be $2,500 and the currently joined passengers A and B are once again notified. Both passengers A and B accept the flight listing at the new cost per passenger, each agreeing to pay $5,000 for two people ($2,500 per passenger) to travel the flight listing. The operator is notified and the flight listing is closed.

While flight listing has been used throughout this application, it is intended that flight listing means any routing or itinerary for travel and can include listings of travel by means other than aircraft, such as by boat or by car. The Internet can be any form of interactive medium that facilitates rapid interactive exchange of data between a plurality of individuals or systems. Charter aircraft operators can be any vendor of a service or product. Passengers can be any user, or potential user, of a service or product. The user need not be a member of the general public, but could be an individual acting on behalf of an organization. The services or products can be any form of craft, container, or vessel that transports people or cargo. Further, the service or product can also be any commodity, not necessarily in the field of transportation. The commodity could be any commodity that is beyond the economic reach of one individual, but by using the present invention, the individual could share the benefits of the commodity by sharing the commodity with other like-minded individuals. Examples include renting of a stadium or other structure, leasing a recreation area, or hiring a symphony orchestra. An open flight list is one that can be joined by other passengers, while a closed flight list is one that cannot be joined by other passengers.

As stated previously, to achieve the above efficiencies of consolidating a plurality of individuals in the purchase of a good or service, the power of the internet and social media is harnessed. The embodiments of the current disclosure thrive in this medium. Users who have access to the internet can avail themselves of the technology. The products or services that would particularly benefit from the system and method described herein are those that are too large, cumbersome, expensive, or too difficult for any one individual person to afford, purchase, or consume.

In a particular embodiment, the process begins with a user going to a designated website and submitting a “request” for a product or service. The user may be required to submit account credentials, such as a username and password, if so desired by the operator of the website. The products or services that are relevant to the invention are those that are too large, cumbersome, expensive, or too difficult for any one individual person to afford and purchase, or consume. As will be appreciated, any user can request a product or service via any type of interactive device; the invention is not limited to just computers, but can be accessed via mobile devices such as mobile phones and tablets.

Vendors of the requested service or product provide a potential solution to the request. The solution includes a total price, the date and time of delivery of the solution, and any other constraining criteria provided by the vendor as it relates to the request made by the user. These solutions provided by vendors may be generated automatically, such as through computerized systems, APIs, or other means, or generated manually, whereby an individual reviews the request and enters in the specified solution into the system.

After a user makes a request, the user is presented with solutions that may have already been requested by other users such that the user may join such a solution. Alternatively, there may be no matching solutions, in which case, a vendor or manufacturer provides a new potential solution, which is displayed to the user. In a similar fashion, other users who have requested a somewhat similar request would be shown this solution. Being made aware of this solution facilitates other like-minded users to join a group of like-minded users. As such, the current invention enables like-minded users to share in the use of the service or consumption of the product.

When certain limits are reached, the system described herein prompts users who have indicated a desire for the product or service to elect to purchase and then pay for the product or service. Should all users agree to purchase the good or service at the specified price, payment is collected via methods known in the art and the system then arranges for the fulfillment of the product or service.

As will be appreciated, the system and method described herein is applicable to many different products and services, including those in transportation, finance, entertainment, education, manufacturing, real estate, construction, and publishing.

In a particular embodiment, the current invention is used by a plurality of individuals for a financial product or service such as banking, capitol formation, investment returns, bonds, and new product development. Any super rich, high net-worth individual could, theoretically, contact a private equity bank and ask for an investment opportunity such as a tax-free investment that yields a minimum of 9% over 30 months and is 60% guaranteed. Such a request may require a minimum investment of $300,000,000 with a maximum investment $350,000,000, which a wealthy individual may avail herself to should she desire.

The system and method according to selected embodiments of the current disclosure can make such a financial product available to a plurality of less wealthy people. The request is made by a user of the system and method as described herein, and the same investment opportunity is returned. The consolidating system enables the consolidation of demand among many users. As more users indicate their desire to join or avail themselves of this opportunity the investment needed be each individual decreases. Therefore, when 3 million indicate their interest, the individual's investment is now only $100.

Similarly, if an entity wanted to raise a certain sum of capital, the consolidating engine could spread that formation over however many wanted to participate. The more users that participate the less each user's investment need be. At the same time, an upper limit may be placed on the number of users joined to any particular solution. In this manner, a range between a minimum investment and a maximum investment (purchase price) may be provided.

With a new product development, or a specific product, it is similar. A request is received for a discreet item. The system of the present invention returns the total price to deliver the request. Again, it is probably beyond the financial resources of an individual. However, by using the consolidating engine, many could consolidate their demand and enjoy the product at a reasonable price.

In a particular embodiment, the current invention is used by a plurality of individuals for entertainment products or services, such as sporting events, recreational events, social events, and concerts. For example, it could be a concert by a well-known artist, a lecture on a special topic by a renowned presenter or educator, a sports match-up of two titans at a special location not frequented by the two teams or players, or the production of an album of a particular performance/performer.

A user will make a request to the system described herein, and the system displays the solution to the request. At first glance, the quoted price would seem to be enormous, and surely beyond the financial means of any one individual. However, using the collaborative powers of the internet and the consolidating engine described herein, many users are able to join together and so share the price and utility, benefits, or use of the entertainment offering at a reasonable and an affordable price point.

In a particular embodiment, the current invention is used by a plurality of individuals for an educational product or service, such as for instructional courses. This group of services and products can be handled in the same way as all the above by the consolidating engine. A request could be for a course, or a course by a specific teacher. It could be any subject. The medium could be video, or sound recording, or live. The point is the service as requested would be beyond the financial reach of any one student. However, the consolidating engine described herein would reduce the price per purchaser so as to make the service/course affordable.

In a particular embodiment, the current invention is used by a plurality of individuals for a manufacturing product or service. Again, using the collaborative power of the internet and the consolidating engine as disclosed herein, anyone could request the manufacture of a certain product. It could be a fashion item, or an electronic gadget, or something that needs to be manufactured in numbers to bring down the cost of an individual item of the requested product. For instance, it could be a special type of garment, or say a smart phone that had a certain shape and performed special features.

The system would supply a solution to the request. The system and method described herein would amortize the total prohibitive cost among a plurality of users, thereby reducing the individual's price. It is important to note that the system and method herein eliminates all financial risk to the manufacturer. The manufacturer always gets the stipulated price. Furthermore, there is no risk of unsold inventory. These factors also contribute to a reduction in the overall price, which is passed through as a reduction in the individual price paid by each user.

In a particular embodiment, the current invention is used by a plurality of individuals for a real estate product or service, such as use or purchase of a hotel or hotel rooms, homes, condos, and resorts. Hotels, homes, condos, resorts all suffer from unused capacity and/or unsold inventory. The system and method disclosed herein, deployed in a similar manner as in the embodiments above, consolidates demand thereby eliminating risk and reducing user costs.

In a particular embodiment, the current invention is used by a plurality of individuals for a construction product or service. A request could well be for a hypothetical condo on a lake/golf course/ski-run. The solution will include the total cost to build the entire development, where the price per user is the total cost divided by the number of users on the interest list of the open request. Again, the consolidating engine would work to remove uncertainty and risk from the equation and so be able to achieve lower cost to potential condo owners.

In a particular embodiment, the current invention is used by a plurality of individuals for a publishing product or service. A request could be for a book, compact disc (CD), digital video disc (DVD), or any work. It could be for a special work of fiction, or a special non-fiction topic, or it could be for something like a special purpose of limited interest appeal. Previous to this invention, the cost to publish something is spread over the estimated market size. The risk of unsold media is borne by the publisher. However, the system and method disclosed herein eliminates the risk, and allows the special purpose consumers to amortize the cost of their demand in real time via the internet thereby reducing the individual's cost, and making the entire publishing concept feasible.

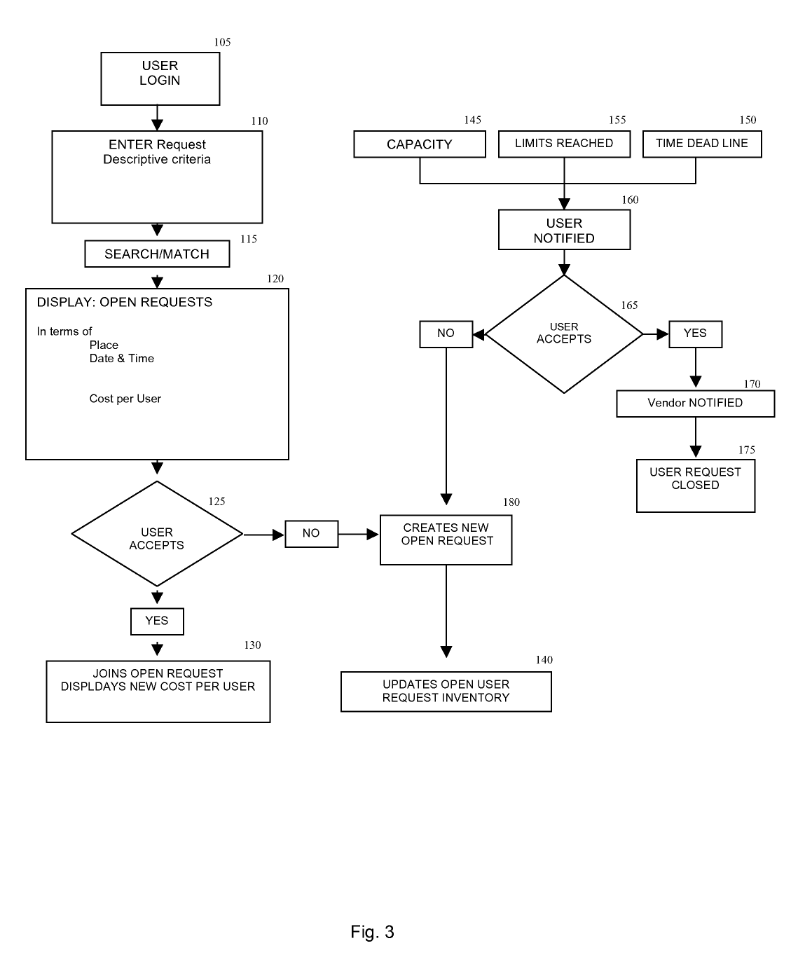

Referring now to FIG. 3, any user may log on to the consolidating engine to request any product or service 105. It is the users who define the product or service. The invention is demand driven, and therefore users, who are the demand side of the commercial transaction, create the request.

The system prompts the user to request a product or service 110. The computer is configured in such a way as to make it easy for the user to describe the product or service. For example, for a Rolling Stone concert in New York State in January; the user could input: “Rolling Stones Concert New York January 2021.” Alternatively, for an investment opportunity, a user could input: “Mostly secure 9% investment for 30 months.” Those skilled in the art of search techniques will appreciate the methods required to parse and search using the inputted strings. In a particular embodiment, the system herein will allow the user to refine or broaden the request by means of prompts and suggestions.

Once the request is sent to the system, the system then searches for similar requests and their solutions offered 115. The system searches the open requests for this set of data. The system then displays the solutions from the list of open requests that meet or are relevant to the submitted request 120. The user either accepts a solution from the available open requests that meet the criteria, or does not 125. If the user accepts the solution as offered, the system adds the user to the interest list of the open request 130. The system updates the interest list of the open request and modifies the information to indicate an additional user. The price per user is similarly updated. The price per user decreases with each additional user. If the user does not accept the solution as offered, the system creates a new open request 180 with just this user on the interest list. This open request is added to the list of open requests 140 and will contain the criteria of the request as inputted by the user. Initially, the cost per user will equal the cost for the entire product or service.

The user is notified 160 when particular limits are reached, such as capacity 145 for the particular service or product, time deadline 150, or some other limits are reached 155. Each user is notified that the limit has been reached, and is prompted to accept or reject the product or service at the price per user 165. This notification can be conducted via any interactive media, including without limitation email, text message, and phone call.

When capacity 145 is reached, regardless of other limits, users are notified 160 that they have to either purchase the product/service or reject such a purchase. Capacity limits could be maximum capacity for a theatre, stadium, number of garments or products in the requested product-run, passenger capacity of the vehicle of transport, or any other meaningful capacity limit. For example, capacity is achieved when it is impossible to seat more people in a venue than legally permissible.

The time deadline 150 is the time after which it becomes impossible to continue the consolidation process. At this time, the users are notified as above by the system and the user must accept or reject 165 the purchase of the product or service.

General limits 155 can also be imposed by the system. They could be input by management. These limits could be, but are not limited to: maximum or minimum investment amounts, frequency of use, or other limits that may have no logical or intuitive reason, but nevertheless they are in place and therefore influence the consolidation process.

Immediately after the limits are reached, the user has to make a decision. Either the user accepts the solution or rejects it 165. If the user declines, the system then creates a new open request for the user 180, and adds it to the open request inventory 140. If the user accepts the solution and all other users for that particular solution accept the solution, then the vendor for that particular solution is notified 170. Furthermore, the system arranges and collects the fees associated with the solution. The price paid by each user is the total price for the solution divided by the number of users. Established methods of payment are employed to facilitate the transaction, such as credit cards, debit cards, Google Wallet™, and PayPal™.

After or while notifying the vendor 170, the open request is closed 175 and becomes a closed request. Users are notified of how to collect their product, or access their service. The system issues discreet notifications so that users may securely gain access to concerts, or receive other purchased commodities.

If one of the users for a particular solution rejects in step 165, while others accept, the remaining users that have accepted the solution are once again notified and asked to accept the revised solution. The solution is revised since the number of users on the interest list has changed. This necessarily changes the price per user, and thus each user must accept the solution at the new price. The process is iterated through until all the users on a particular interest list of an open request agree to purchase the product or service at the specified price, thereby leading to step 170.

The system of the current invention can be implemented using one or more computers, or servers, connected to the Internet. These servers accept requests by users made over the Internet and return requested data. Specifically, the data is stored within a computer readable medium, preferably a database, and the users access and modify the data in the computer readable medium by accessing a server system (one or more servers) over the Internet. The software used to implement the current method can be written in one or more different programming languages and electronic document formats, including without limitation Java, JavaScript, PHP, HTML, ASP, ActionScript, Python, and CSS. The web platform is particularly well suited for the current system and method because of its wide availability and rapid interactive electronic communication capabilities.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A system for consolidating a purchase of a product or service among a plurality of users comprising
a computer readable medium and a server system, where the computer readable medium stores data,
where the server system is configured to store requests in the computer readable medium, where a request comprises a product or service and an associated total cost,
where the server system is configured to receive a request for product or service from a user over the internet, wherein the request comprises product or service criteria, and transmitting a response of open requests based upon the criteria,
where the server system is configured to join one or more users to an open request whereby the one or more users are added to an interest list,
where the server system is configured to calculate a price per user, where the price per user is the total cost for the request divided by the number of users on the interest list of the request,
where the server system is configured to notify users on the interest list of an open request upon an occurrence of a limiting event, where upon notification, users can accept or reject the request, where upon one or more users rejecting the request, removing the users that rejected request from the interest list, recalculating the price per user, and notifying users of the interest list of the request, where upon all users accepting the request, closing the request.

2. The system of claim 1, wherein the computer readable medium is a database.

3. The system of claim 1, wherein the server is configured to obtain the total cost from a vendor.

4. The system of claim 3, wherein the total cost is obtained through an application programming interface.

5. The system of claim 1, wherein the limiting event is a period of time before a service is to be performed.

6. A method for purchasing a product or service over the internet comprising
receiving search criteria for a product or service from a user, where the user sends the search criteria through a web browser;
sending open requests to the user, where the user can view the open requests through a web browser;
joining the user to an open request;
joining additional users to the open request; and
notifying the users upon the occurrence of a limiting event, where the users are notified of the price per user of the request, where the users are allowed to accept or reject the open request;
where the open request has a total cost, where the price per user is the total cost divided by the number of users that have joined the open request.

7. The method of claim 6, further comprising the step of
recursively removing users that reject the open request, recalculating the price per user, and notifying the users still joined to the open request until either all users accept the open request or all users are removed from the open request.

8. The method of claim 6, further comprising the step of
notifying a vendor capable of fulfilling the request if all users joined to an open request accept the open request.

9. The method of claim 6, further comprising the step of
closing the open request.

10. The method of claim 6, wherein the user joins an open request by selecting a previously created open request.

11. The method of claim 6, further comprising the step of creating a new open request, where the user joins the new open request.

12. The method of claim 6, further comprising the step of
determining the total cost by accessing an application programming interface.

13. The method of claim 6, wherein the request is for a service.

14. The method of claim 6, wherein the request is for a product.

15. The method of claim 6, wherein the limiting event is the total number of users joined to the open request equaling or exceeding a threshold value.

16. The method of claim 13, wherein the limiting event is a period of time before the service is to be performed.

17. A method for purchasing a product or service comprising
receiving search criteria from a user, where the user sends the search criteria through a web browser;
sending open requests to the user, where the user can view the open requests through a web browser, where each open request comprises a price per user;
joining the user to an open request;
joining additional users to the open request; and
notifying the users upon the occurrence of a limiting event, where the users are notified of the price per user of the request, where the users are allowed to accept or reject the open request; and
recursively removing users that reject the open request, recalculating the price per user, and notifying the users still joined to the open request until either all users accept the open request or all users are removed from the open request;
where the open request has a total cost, where the price per user is the total cost divided by the number of users that have joined the open request.

18. The method of claim 17, wherein users are notified by sending an electronic mail message.

19. The method of claim 17, further comprising the step of
creating a new open request after a user rejects the open request.

20. The method of claim 17, further comprising the step of
closing the open request.
